(19) United States
(12) Patent Application Publication
(10) Pub. No.: US 2020/0062335 A1
(43) Pub. Date: Feb. 27, 2020

(54) CONTROL METHOD AND DEVICE FOR AN ANTILOCK BRAKING SYSTEM OF A TWO-WHEELED VEHICLE

(71) Applicant: Robert Bosch GmbH, Stuttgart (DE)

(72) Inventors: Andreas Wienss, Eningen Unter Achaim (DE); Daniel Baumgaertner, Tübingen (DE); Georg Widmaier, Leonberg (DE); Gregor Dasbach, Tübingen (DE); Juergen Stegmaier, Tuebingen (DE); Rinaldo Greiner, Reutlingen (DE); Tim Dackermann, Tuebingen (DE)

(21) Appl. No.: 16/467,276

(22) PCT Filed: Nov. 16, 2017
(86) PCT No.: PCT/EP2017/079473

§ 371 Date: Jun. 6, 2019

(30) Foreign Application Priority Data
Dec. 19, 2016 (DE) 10 2016 225 492.8

(51) Int. Cl. B62L 3/00; B60T 7/12; B60T 8/17; B60T 8/176; B60T 8/32

(52) U.S. Cl. CPC B62L 3/00; B60T 7/12; B60T 8/1706; B62J 2099/002; B60T 8/3225; B60T 8/329; B60T 2230/03; B60T 8/176

(57) ABSTRACT

A control method includes at least one emission of a radar signal into an area that encompasses a base surface of the roadway section and a wheel of a vehicle, for example an electric bicycle. A radar frequency spectrum reflected on the base surface and on the wheel is subsequently detected using the radar sensor. A control unit actuates at least one brake, for example a front wheel brake of the electric bicycle, as a function of a difference between the vehicle speed and the wheel speed recognized based on the detected radar frequency spectrum.

### CROSS-REFERENCE TO RELATED APPLICATIONS

The present application is the national stage of International Pat. App. No. PCT/EP2017/079473 filed Nov. 16, 2017, and claims priority under 35 U.S.C. § 119 to DE 10 2016 225 492.8, filed in the Federal Republic of Germany on Dec. 19, 2016, the content of each of which are incorporated herein by reference in their entireties.

### FIELD OF THE INVENTION

The present invention relates to a control method for an antilock braking system of a vehicle, a control unit, and a vehicle that includes the control unit, the control unit being configured for carrying out the control method.

### BACKGROUND

The difference between a wheel speed of a vehicle and the vehicle speed, normalized to the vehicle speed, is referred to as the slip value of the wheel. When drive or brake forces are transmitted to a wheel of a vehicle, the vehicle speed and wheel speed differ from each other, resulting in a slip value greater than zero. In the event of a heavy brake application, the maximum static friction force can be exceeded, resulting in sliding friction, for example, so that the slip value increases sharply and steering the vehicle becomes difficult or impossible.

The documents DE 195 08 915 A1 and DE 101 58 382 A1 describe a control method for an antilock braking system on a bicycle.

### SUMMARY

An object of the present invention is to allow provision of an antilock braking system on a vehicle in a reliable and cost-effective manner. The vehicle is, for example, an electric bicycle.

The vehicle according to the present invention includes at least one wheel and an antilock braking system. The antilock braking system of the vehicle includes at least one actuatable brake, for example a disk brake. A radar sensor and a control unit for actuating the brake are also situated on the vehicle as components of the antilock braking system. The radar sensor emits a radar signal into an area, the area encompassing a base surface of the roadway section and a wheel of the vehicle. The radar signal is reflected on the base surface and on the wheel. The radar sensor subsequently detects a radar frequency spectrum that is reflected on the base surface and on the wheel.

In an example embodiment, the vehicle includes an optional speed sensor. The speed sensor is configured for detecting a vehicle speed.

In addition, the vehicle can include at least one sensor for recognizing a lift-off of a rear wheel. The sensor is preferably an acceleration sensor that detects an acceleration in the direction of the vertical axis of the vehicle. Two acceleration sensors can be situated on the vehicle for recognizing the lift-off of the rear wheel. Alternatively, the sensor is a distance sensor that is configured for detecting a distance between a frame of the vehicle or the rear wheel of the vehicle and the base surface of the roadway section.

Furthermore, the vehicle can optionally include an adjustable spring element, in particular a suspension fork. The spring element is configured for adjustment into a rigid operating state.

According to an example embodiment, a control method includes at least one emission of a radar signal in the area encompassing the base surface of the roadway section and a wheel of the vehicle. The radar frequency spectrum reflected on the base surface and on the wheel is subsequently detected using the radar sensor.

According to the Doppler effect, a speed of the vehicle can be ascertained from a frequency shift of the detected radar frequency spectrum relative to the emitted radar signal. If the wheel is locked in the area covered by the radar signal, the wheel speed differs from the vehicle speed, and the detected radar frequency spectrum has two local maxima. A deviation of the vehicle speed from the wheel speed, i.e., the locking of the wheel or the slip value, can thus be ascertained from the detected radar frequency spectrum.

In a subsequent step, the at least one brake is actuated as a function of a recognized difference between the vehicle speed and the wheel speed, based on the detected radar frequency spectrum, using the control unit. The brake is preferably a front wheel brake and/or a rear wheel brake of an electric bicycle. As the result of actuating the brake, the brake is at least temporarily disengaged, or there is at least a temporary reduction in the brake pressure of the brake.

By use of the control method, locking of at least one wheel, preferably a front wheel of an electric bicycle, is avoided, so that it is still possible to steer the vehicle with the wheel. The method has an advantage over the control methods for antilock braking systems described in the related art that use radar sensors for speed detection, in that the antilock braking system includes only one radar sensor. This is made possible by a small wheel width of the vehicle, for example in particular an electric bicycle, as the result of which the detected radar frequency spectrum contains information concerning the vehicle speed and the wheel speed due to the back reflection of the radar signal on the wheel and the base surface of the roadway section. The wheel width is typically less than or equal to 100 mm.

In an example embodiment, the control method encompasses a detection of a vehicle speed using a speed sensor that is situated on the vehicle, in this embodiment the actuation of the brake additionally taking place as a function of the ascertained vehicle speed. The actuation of the brake in this embodiment is advantageously more accurate, thus increasing the riding safety for the rider of the vehicle.

In an example embodiment, the control method encompasses a recognition of the lift-off of the rear wheel of the vehicle as a function of the detected acceleration in the direction of the vertical axis of the vehicle and/or the detected distance from the base surface. In this embodiment, the actuation of the brake takes place also as a function of the recognized lift-off. This has the advantage that in the event of lift-off of the rear wheel, for example the brake pressure of the front wheel brake of an electric bicycle is reduced or the front wheel brake is disengaged, thus reducing the risk of a rollover about the transverse axis of the vehicle.

In an example embodiment, the control method encompasses an adjustment of the at least one adjustable spring element into a rigid operating state as a function of the recognized difference between the vehicle speed and the wheel speed. In this way, in particular a rotation or pitching about the transverse axis of the vehicle during braking of the vehicle is avoided, i.e., the braking and steering of the vehicle take place in a more controlled manner.

An example embodiment of the present invention is directed to the control unit. The control unit includes at least one processing unit, the processing unit being configured for carrying out the control method. The processing unit detects a first sensor signal from the radar sensor, the first sensor signal representing the detected radar frequency spectrum. The processing unit also generates at least one first control signal for actuating the at least one brake as a function of the detected first sensor signal.

The control unit preferably detects a second sensor signal from the speed sensor, the second sensor signal representing the vehicle speed. In this embodiment, the processing unit generates the first control signal for actuating the brake also as a function of the second sensor signal.

In an example embodiment, the processing unit detects a third sensor signal, the third sensor signal representing the lift-off of the at least one rear wheel. In this embodiment, the first control signal for actuating the brake is generated also as a function of the third sensor signal.

The processing unit can optionally generate a second control signal for adjusting the at least one adjustable spring element as a function of the recognized difference between the vehicle speed and the wheel speed.

The present invention is explained below with reference to preferred example embodiments and the appended drawings.

### BRIEF DESCRIPTION OF THE DRAWINGS

FIG. 1 shows an electric bicycle according to an example embodiment of the present invention.

FIG. 2 shows a block diagram of a control unit according to an example embodiment of the present invention.

FIG. 3 is a flowchart of a control method according to an example embodiment of the present invention.

FIG. 4 shows an example detected radar frequency spectrum with no deviation between the vehicle speed and the wheel speed.

FIG. 5 shows an example detected radar frequency spectrum with a deviation between the vehicle speed and the wheel speed, i.e., with a locked wheel.

### DETAILED DESCRIPTION

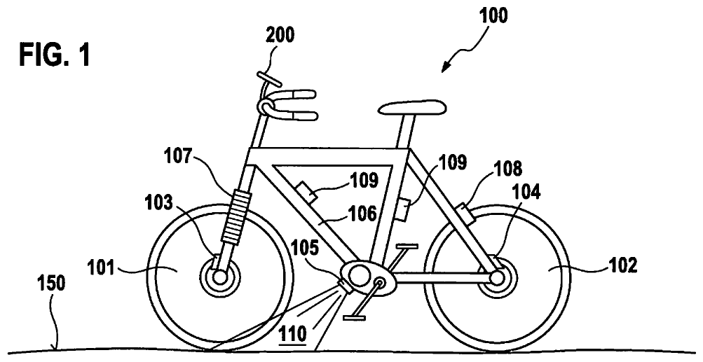

FIG. 1 shows an electric bicycle as vehicle 100. Electric bicycle 100 includes a frame 106, and a front wheel 101, and a rear wheel 102 as wheels. Also situated on electric bicycle 100 are a control unit 200 and a front wheel brake 103, and a rear wheel brake 104 as brakes. Front wheel brake 103 and rear wheel brake 104 are designed as disk brakes. Alternatively, other types of brakes, for example rim brakes, can be situated on front wheel 101 as a front wheel brake 103 and/or on rear wheel 102 as a rear wheel brake 104. A speed sensor 108 and two acceleration sensors 109 are also situated on electric bicycle 100. Speed sensor 108 is configured for detecting a vehicle speed in the travel direction. The at least one acceleration sensor 109 is configured for detecting an acceleration of electric bicycle 100 in the direction of the vertical axis of electric bicycle 100, so that a lift-off of rear wheel 102 can be recognized. Electric bicycle 100 travels on a base surface 150 of a roadway section.

The antilock braking system of electric bicycle 100 includes at least control unit 200 and a brake 103 and/or 104, in particular front wheel brake 103. The antilock braking system of electric bicycle 100 preferably also includes optional rear wheel brake 104. In addition, the antilock braking system of electric bicycle 100 includes a radar sensor 105. In this example embodiment, radar sensor 105 is situated on a frame 106 of electric bicycle 100 or on the motor housing of electric bicycle 100. Radar sensor 105 emits a radar signal into an area 110.

Area 110 of the emitted radar signal encompasses a base surface 150 of the roadway section and front wheel 101 of electric bicycle 100. For example, radar sensor 105 is situated on the motor of electric bicycle 100 and emits the radar signal in the direction of the longitudinal axis, toward the front and downwardly in the direction of the vertical axis. Radar sensor 105 also detects a radar frequency spectrum that is reflected on base surface 150 and on front wheel 101. If front wheel 101 locks up due to braking of electric bicycle 100 with front wheel brake 103, a wheel speed of front wheel 101 differs from the vehicle speed of electric bicycle 100, thus making it difficult to steer electric bicycle 100. When a front wheel 101 is locked or when there is a deviation of the wheel speed of front wheel 101 from the vehicle speed of electric bicycle 100, according to the Doppler effect the radar frequency spectrum shows a broader frequency distribution, i.e., two pronounced maxima, that can be associated with the wheel speed and the vehicle speed, respectively. A deviation of the vehicle speed from the wheel speed or locking of wheel 101 or 102 is accordingly recognized based on the detected radar frequency spectrum. Alternatively, radar sensor 105 can emit the radar signal in the direction of the longitudinal axis, toward the rear and downwardly in the direction of the vertical axis, as the result of which the radar signal covers base surface 150 and rear wheel 102.

In addition, electric bicycle 100 includes at least one adjustable suspension fork as an adjustable spring element 107. Adjustable spring element 107 can also be situated at other locations on vehicle 100, for example on the seat tube of frame 106. Suspension fork 107 is configured for damping impacts of front wheel 101 on frame 106 of electric bicycle 100, it being possible for the suspension fork to be mechanically rigidly adjusted into a defined operating state. In an example embodiment, control unit 200 of electric bicycle 100 is configured for adjusting suspension fork 107 into the rigid operating state. By use of the control method, the rigid operating state reduces repeated turning of electric bicycle 100 back and forth about its transverse axis during the braking operation.

Control unit 200 can additionally be configured for controlling, for example, an electric motor of electric bicycle 100 as a drive motor as a function of a detected pedaling torque generated by the cyclist. Alternatively, a separate motor control unit can be provided for controlling the electric motor.

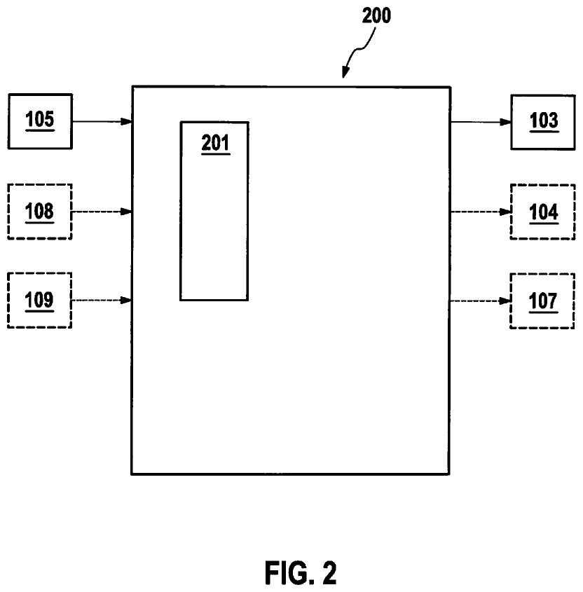

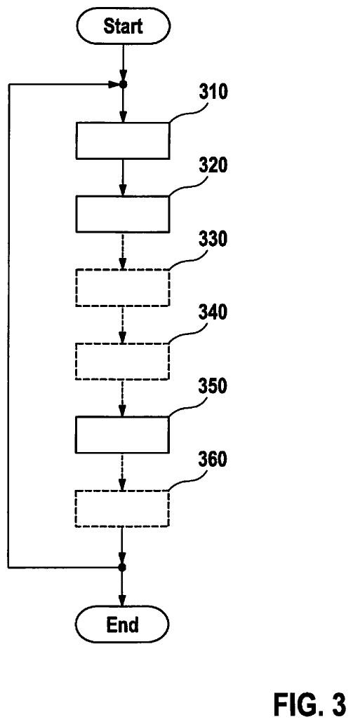

Control unit 200 includes a processing unit 201 (see FIG. 2). Processing unit 201 detects a first sensor signal from radar sensor 105. The first sensor signal represents the radar frequency spectrum that is reflected on front wheel 101 or rear wheel 102 and base surface 150, and detected by first radar sensor 105. With reference to also FIG. 3, processing unit 201 generates at least one first control signal for actuating (350) the at least one brake 103, 104 as a function of the detected first sensor signal.

In an example embodiment, processing unit 201 can detect a second sensor signal from speed sensor 108, in this embodiment the first control signal being generated for actuating (350) front wheel brake 103 also as a function of the second sensor signal.

In an example embodiment, processing unit 201 can detect a third sensor signal from sensor 109, in this embodiment the first control signal being generated for actuating (350) front wheel brake 103 also as a function of the third sensor signal. Optional sensor 109 detects the lift-off of rear wheel 102. Sensor 109 is an acceleration sensor, for example, which detects an acceleration in the direction of the vertical axis of electric bicycle 100. Multiple acceleration sensors 109 can be provided. Alternatively, sensor 109 is a distance sensor that determines a distance of frame 106 or of rear wheel 102 from base surface 150 of the roadway section.

Processing unit 201 also optionally generates a second control signal for adjusting (380) adjustable spring element 107 into the rigid operating state as a function of the detected first sensor signal.

FIG. 3 is a flowchart of a control method. The radar signal is emitted into area 110 using radar sensor 105 in a first step 310. For example, the radar signal, as illustrated in FIG. 1, is emitted in the direction of the longitudinal axis, toward the front and downwardly in the direction of the vertical axis. Area 110 encompasses base surface 150 of the roadway section as well as one wheel 101 or 102, in particular front wheel 101. The radar frequency spectrum reflected on base surface 150 and on wheel 101 or 102 is detected in a second step 320. The speed of vehicle 100 is detected using a speed sensor 108 in an optional step 330. In addition, the lift-off of rear wheel 102 can be recognized using sensor 109 in optional step 340. In step 350, actuation of brake 103 and/or 104 takes place at least based on the detected radar frequency spectrum. Optionally, the actuation of brake 103 and/or 104 can additionally be carried out as a function of the detected speed and/or the recognized lift-off of rear wheel 102. In addition, adjustable spring element 107 can be adjusted 360 in a subsequent step 360.

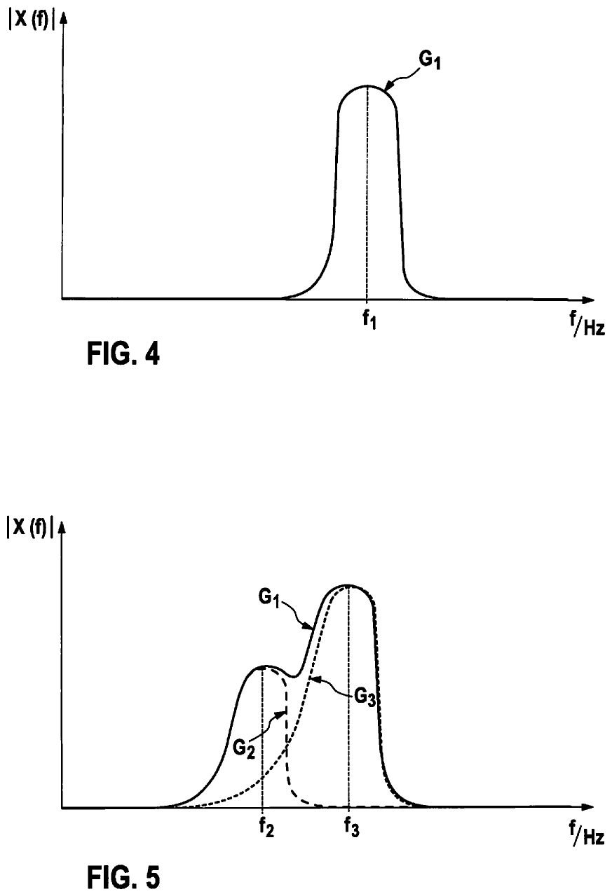

FIG. 4 illustrates a radar frequency spectrum during travel of electric bicycle 100 without front wheel slip. Function graph G₁, and frequencies f of the illustrated radar frequency spectrum, change as a function of the vehicle speed, i.e., the vehicle speed can be ascertained from the frequency spectrum according to the Doppler effect. The differences in frequencies between the first radar signal that is reflected on base surface 150 and on front wheel 101 are small, for which reason the function graph has only one maximum at frequency f₁. Amplitude |X(f₁)| at the maximum and/or the half-value width of function graph G₁ at the maximum are a function of the characteristics of base surface 150 and/or of front wheel 101.

FIG. 5 illustrates a radar frequency spectrum detected in step 320 during braking with locking front wheel 101. In this case, the vehicle speed of electric bicycle 100 is greater than the wheel speed of front wheel 101, i.e., there is a difference between the vehicle speed and the wheel speed. According to the Doppler effect, the radar frequency component of the detected radar frequency spectrum that is reflected from base surface 150 and is represented by function graph G₃, and the radar frequency component of the detected radar frequency spectrum that is reflected from front wheel 101 and is represented by function graph G₂, have different frequencies f and amplitudes |X(f₁)|. In other words, the difference in frequencies between radar frequency component G₃ reflected from base surface 150 and the emitted radar signal is greater than the difference in frequencies between radar frequency component G₂ reflected from front wheel 101 and the emitted radar signal. The detected radar frequency spectrum, which is represented by function graph G₁, therefore shows two maxima. Thus, a difference between the vehicle speed and the wheel speed, i.e., locking of front wheel 101, can be recognized by analyzing the radar frequency spectrum or by identifying two maxima at frequencies f₂ and f₃. At least one brake of the vehicle is actuated according to the control method when a difference between the vehicle speed and the wheel speed is recognized based on the detected radar frequency spectrum, for example by identifying two maxima in the radar frequency spectrum.

In addition, a degree of wetness NG of base surface 150 of the roadway section can be determined as a function of amplitude |X(f)| of the radar frequency component of the detected radar frequency spectrum, which is reflected from front wheel 101 and represented by function graph G₂, by comparison with amplitude reference values, for example at the maximum of function graph G₂. In this example embodiment, the actuation in step 350 of the at least one brake 103 and/or 104 can additionally take place as a function of determined degree of wetness NG of base surface 150.

1-12. (canceled)

13. A control method for an antilock braking system of a vehicle, the vehicle including at least one actuatable brake, a radar sensor, and a control unit, the control method comprising:
emitting at least one radar signal into an area, the area including a base surface of a roadway section and a wheel of the vehicle;
detecting, using a radar sensor, a radar frequency spectrum that is reflected by the base surface and by the wheel in response to the emitted at least one radar signal; and
a control unit actuating the brake based on the detected radar frequency spectrum.

14. The control unit of claim 13, further comprising determining a difference between a vehicle speed and a wheel speed based on the detected radar frequency spectrum, wherein the actuating of the brake is based on the determined difference.

15. The control method of claim 13, wherein the vehicle is a bicycle.

16. The control method of claim 13, further comprising:
detecting a vehicle speed using a speed sensor that is situated on the vehicle, wherein the actuation of the brake is further based on the detected vehicle speed.

17. The control method of claim 13, further comprising:
recognizing a lift-off of a rear wheel of the vehicle based on a sensor detection of (a) a detected acceleration in a direction of a vertical axis of the vehicle and/or (b) a detected distance from the base surface, wherein the actuation of the brake is further based on the recognized lift-off.

18. The control method of claim 14, further comprising adjusting at least one adjustable spring element into a rigid operating state based on the determined difference between the vehicle speed and the wheel speed.

19. A control unit comprising a processor configured to perform a control method for an antilock braking system of a vehicle, the vehicle including at least one actuatable brake and a radar sensor, the method comprising:
determining, based on a sensor signal received from a radar sensor, a radar frequency spectrum that is reflected, by a base surface and by a wheel of the vehicle, when a radar signal is emitted into an area including the base surface and the wheel; and
generating a control signal configured to actuate the brake based on the determined radar frequency spectrum.

20. The control unit of claim 19, wherein the processor is configured to:
obtain from a speed sensor a sensor signal that represents a speed of the vehicle; and
generate the control signal based additionally on the speed of the vehicle.

21. The control unit of claim 19, wherein the processor is further configured to:
obtain a sensor signal representing a lift-off of a rear wheel of the vehicle, wherein the control signal is generated further based on the lift-off.

22. The control unit of claim 19, wherein the processor is configured to generate a second control signal for adjusting at least one adjustable spring element based on a recognized difference between a speed of the vehicle and a speed of the wheel.

23. A vehicle comprising:
an actuatable brake,
a radar sensor, wherein the radar sensor is configured to:
emit a radar signal into an area that includes a base surface of a roadway section and a wheel of the vehicle; and
detect a radar frequency spectrum that is reflected by the base surface and the wheel in response to the emitted radar signal; and
a control unit, wherein the control unit is configured to actuate the brake based on the detected radar frequency spectrum.

24. The vehicle of claim 23, further comprising a speed sensor that is configured to detect a vehicle speed.

25. The vehicle of claim 23, further comprising a sensor configured to detect a lift-off of a rear wheel of the vehicle.

26. The vehicle of claim 25, wherein the sensor is an acceleration sensor.

27. The vehicle of claim 25, wherein the sensor is a distance sensor.

28. The vehicle of claim 23, further comprising an adjustable spring element adjustable into a rigid operating state.
